(19) United States
(12) Patent Application Publication
(10) Pub. No.: US 2008/0205755 A1
(43) Pub. Date: Aug. 28, 2008

(54) Method and apparatus for color matching

(75) Inventors: Bennett William Jackson, Minneapolis, MN (US); Lawrence Lee Reiners, Apple Valley, MN (US)

Correspondence Address: MERCHANT & GOULD PC, P.O. BOX 2903, MINNEAPOLIS, MN, 55402-0903, US

(73) Assignee: Banner Engineering Corporation

(21) Appl. No.: 11/710,157

(22) Filed: Feb. 23, 2007

(51) Int. Cl. G06K 9/00

(52) U.S. Cl. 382/168

(57) ABSTRACT

This disclosure generally relates to identifying objects by comparing their histograms. In aspect, the histograms of different color resolutions are constructed for each image and each compared to a corresponding histogram of another image. The results of the comparisons are combined to obtain an indicator of the difference between the color contents of the images and can be used to determine whether the images match each other. In another aspect, the color space is divided unevenly for each histogram, with the portions of the color space corresponding to white or gray being more finely divided than the portions corresponding to more saturated colors.

### TECHNICAL FIELD

This disclosure relates to color matching. Specific arrangements also relate to methods and devices for comparing colors of two images using color histograms.

### BACKGROUND

Color matching relates to comparing the color contents of two or more objects and has a wide range of applications in automated vision. For example, one aspect of mechanized inspection is to automatically ascertain whether an object being inspected has correct components in their proper positions. The task is essentially one of checking whether the image (“target image”) of the object being inspected matches that (“reference image”) of an object of a known pattern. It is known that, without any spatial information comparison, images can be efficiently compared to each other using color information only. In particular, color histograms of a target image and reference image can be compared to each other in determining the degree of similarity between the two.

While conventional color matching methods and systems utilizing color histograms have produced acceptable results for some applications, improvements in reliability and/or efficiency are needed.

### SUMMARY OF THE DISCLOSURE

This disclosure generally relates to identifying objects by comparing their histograms. More specifically, the histograms of different color resolutions are constructed for each image and each compared to a corresponding histogram of another image. The results of the comparisons are combined to obtain an indicator of the difference between the color contents of the images and can be used to determine whether the images match each other.

### BRIEF DESCRIPTION OF THE DRAWINGS

FIG. 1 is a schematic graphical representation of an example of dividing color space into a 16×16 histogram according to another aspect of the present disclosure.

FIG. 2 is an example of a 64×64 histogram with non-uniform numerical ranges of normalized chromaticity according to another aspect of the present disclosure.

FIG. 3 is a schematic diagram of a system for identifying objects according to an aspect of the present disclosure.

### DETAILED DESCRIPTION

### I. Overview

This disclosure relates to determining whether two or more images match each other by comparing their color contents, as measured by their color histograms, i.e., counts or proportions of pixels in their respective color ranges or normalized color ranges, sometimes referred to as “bins”. More particularly, the disclosure relates to comparing the histograms of the images at varying levels of granularity of the histograms and using a combination of the comparisons as a measure of degree of similarity between the images. Using this method, degrees of similarity between histograms on both coarse and fine scales are taken into account. The level of confidence in the determination as to match is thus enhanced over comparing only a single pair of color histograms.

According to one aspect of the present disclosure, a method of comparing a first and a second image portions over at least a subset of a color space comprises the following steps: for each of the first and second image portions, generating a corresponding set of histograms of the image portion, each of the histograms being over a different number of bins spanning the subset of the color space. Each of the histograms is generated by counting the numbers of pixels falling within each bin. A degree of difference (e.g., histogram intersection) between each pair of histograms having the same number of bins for the first image portion and the second image portion is computed. A combination (e.g., a weighted sum) of the degrees of difference computed for the different number of bins is then calculated.

The combination can then be used to determine (e.g., by comparing with a predetermined threshold) if the two image portions match each other.

As used in this disclosure, a “color range”, or “bin”, refers to a unit of the color space and can be represented in a variety of coordinate system. For example, it can be a three-dimensional unit in the red-green-blue (RGB) space or hue-saturation-intensity (HSI) space. As another example, it can also be a two dimensional unit in a chromaticity space, where the color space is spanned by intensities of two of the three base colors, such as red and green, divided by the total intensity.

The illustrative method disclosed in the present application can be computer-implemented. In another aspect of the present disclosure, a system for identifying an object includes an imaging device for obtaining a digital image of the object and an image processing unit programmed to compare at least a region-of-interest (ROI) in the digital image with a reference image in the manner outlined above. Alternatively, histograms of the reference image need not be computed every time histograms of an ROI are computed, but can instead be pre-computed and stored, and be used repeatedly to identify multiple objects.

### II. Example Processes and Configurations

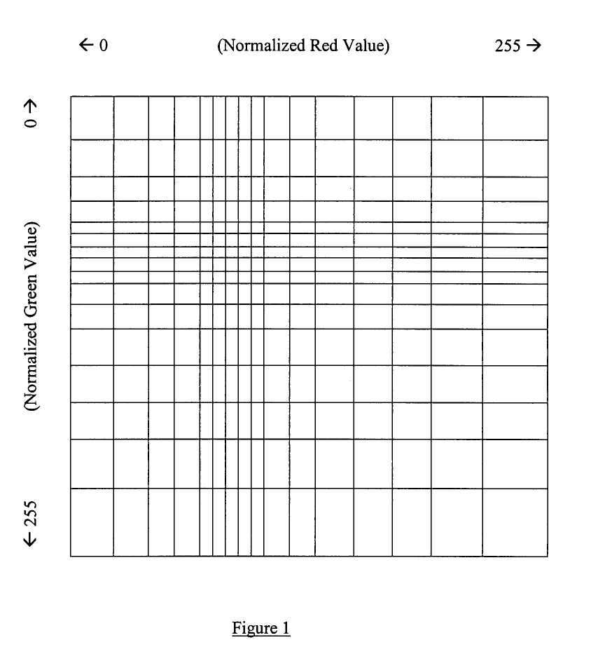

A process and system for object identification using color matching are now described with reference to FIGS. 1-3.

### A. Constructing Color Models

A Color Model is a description of a region that may contain a single, very pure color, or a wide mix of colors. In one aspect of the present disclosure, a Color Model includes multiple histograms of different granularity, i.e. with different number of bins.

1. Histograms with Different Granularity

In an example of a process of characterizing the color content of an image (image of an object or reference image), four two-dimensional histograms are used. These histograms are labeled H₀, H₁, H₂ and H₃, respectively and have following respective dimensions:

8×8, 16×16, 32×32, 64×64.

Thus, the number of bins along each of the two dimensions of the color space is successively doubled for the histograms. In this example, the two dimensions in each histogram correspond to two dimensions of chromaticity: normalized red and normalized green. This chromaticity computation removes intensity information. The two normalized values are computed as follows:

N_{RED}=(255×RGB_{RED})/(RGB_{RED}+RGB_{GREEN}+RGB_{BLUE}), and N_{GREEN}=(255×RGB_{GREEN})/(RGB_{RED}+RGB_{GREEN}+RGB_{BLUE}),

wherein N_{<COLOR>} denotes the normalized intensity for the color component (red or green in this case, and RGB_{<COLOR>} denotes the intensity of the color component (red, green or blue in this case). RGB_{RED}+RGB_{GREEN}+RGB_{BLUE} is the total light intensity (or grayscale). Thus, normalized red and normalized green are each in the range 0 to 255.

### 2. Non-Linear Mapping of Color Space.

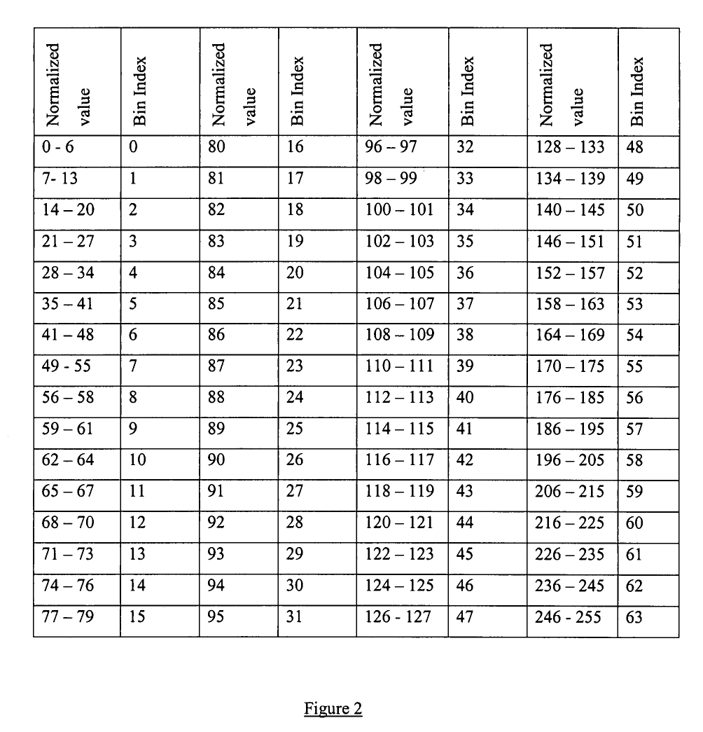

In a further aspect of the present disclosure, in order to make a fixed sized step within this chromaticity space correspond approximately to a fixed sized step in human perception, a non-linear mapping is applied to the normalized red and green values. This mapping is from normalized value to histogram bin number. That is, bins in a histogram do not all encompass the same range of normalized colors. FIG. 1 schematically shows an example of how the 16×16 histogram spans the normalized color space. FIG. 2 shows an example of the normalized color range assigned to each bin for a 64×64 histogram. For example,

Note that, according to another aspect of the present disclosure, the color space is more finely divided in a region centered about a point where the normalized colors are about equal to each other, with each being about ⅓ of the maximum value (i.e., at about N_{<COLOR>}≈⅓×255=85), than in regions where any of the normalized color is close to either 0 or 255. The mapping is designed to give greater sensitivity around gray and white, and reduced sensitivity in the saturated colors.

### 3. Steps in Constructing Histograms.

A complete set of histograms for an ROI or image is built as follows in one example of the present disclosure:
a. The grayscale values of all pixels within the ROI are summed and divided by the total number of pixels in the region to obtain an average intensity. The average intensity, although not directly used in constructing the histograms, can be used to calibrate measurements of color intensity.
b. Histogram H₃ (64×64) is populated by computing the normalized red and green chromaticity values for each pixel, looking up the bin indices in the lookup table, and incrementing the count of pixels in the corresponding bin.
c. Histograms H₂ through H₀ are populated by “decimating” the next greater histogram, i.e., by effectively combining several (e.g., 4) bins in Hₙ to form a single bin in Hₙ₋₁. In one example, each bin [i, j] in the smaller histogram (Hₙ₋₁) is the sum of four bins in the larger histogram (Hₙ):

| | |
|---|---|
| a. [i*2, | j*2] |
| b. [i*2 + 1, | j*2] |
| c. [i*2, | j*2 + 1] |
| d. [i*2 + 1, | j*2 + 1] |

### B. Comparing Two Color Models

In the example above, each color model has four histograms, H₀ to H₃. In order compare color models of two images, each pair of histograms must be compared. These comparisons can be done in a variety of ways, including using the histogram intersection algorithm. For a general description of the algorithm, see, e.g, M. J. Swain and D. H. Ballard, “Color Indexing”, International Journal of Computer Vision, 7:11-32 (1991). For a pair of histograms, I and M, each having n bins, their non-normalized histogram intersection is defined as

$${\sum }_{j = 1}^{n} min ( {I}_{j} , {M}_{j} )$$

The normalized histogram intersection, denoted HI in the present application, is the non-normalized histogram intersection divided by the total number of items (pixels) in M (i.e.,

$${\sum }_{j = 1}^{n} {M}_{j}$$

). Thus, for the mth pair of histograms,

$${HI}_{m} = {\sum }_{j = 1}^{n} min ( {I}_{m , j} , {M}_{m , j} ) / {\sum }_{j = 1}^{n} {M}_{m , j} .$$

Each comparison yields a normalized histogram intersection, which is a number between zero and one. These four numbers are then combined into a single value to get the final match percentage.

In one example, the following computer algorithm is used to calculate each normalized histogram intersection between a query histogram (of an ROI) and a reference histogram (for a reference image):

| | |
|---|---|
| 1. | Sum = 0 |
| 2. | Rₜₒₜₐₗ = total number of items in the reference histogram |
| 3. | For each bin, R, in the reference histogram, and the corresponding |
| | bin Q, in the query histogram: |

If R > Q then

Sum = Sum + Q
R = R − Q
Q = 0

Else

Sum = Sum + R
Q = Q − R
R = 0

| | |
|---|---|
| 4. | Reduce the value of all the bins in the query histogram by |
| | some fraction, K, where 0 <= K <= 1. |
| 5. | For each bin R in the reference histogram |

| | |
|---|---|
| a. | For each bin Q′ in the query histogram that is an |
| | immediate neighbor of the bin corresponding to R: |

If R > Q′ then

Sum = Sum + Q′
R = R − Q′
Q′ = 0

Else

Sum = Sum + R
Q′ = Q′ − R
R = 0

| | |
|---|---|
| 6. | The final result, HI = Sum / Rₜₒₜₐₗ |

In the process above, steps 4 and 5 are used to take into account bias caused by the binning process in constructing histograms and to take into account noise by allowing “extra” pixels in nearby bins to partially count as matches. For example, K≈0.6 can be used, and the result has approximately the same effect of Gaussian blurring of histograms.

### B. Computing the Final Match Percentage

By running the histogram intersection algorithm on each pair of histograms, four numbers (HI₀, HI₁, HI₂ and HI₃) in the range zero to one are generated. Denote the comparison of the two 8×8 histograms HI₀, the two 16×16 histograms HI₁ and so on. The final match percentage value, is computed as follows:

Match Percentage=T×( 16/15), where T=(HI₀/2)+(HI₁/4)+(HI₂/8)+(HI₃/16)

That is, the match percentage is proportional to a weighted sum of the normalized histograms, with the intersections for the smaller histograms (i.e., those with larger bins) given more weight than those for the larger histograms. The result is multiplied by 16/15 because the highest possible value T is 15/16, and a result that uses the whole range from 0 to 1 is desired for this example.

A decision can then be made about whether two colors are the same by applying a threshold to the match percentage or the difference between the intensities, or both.

### C. System for Implementing the Color Matching Algorithm

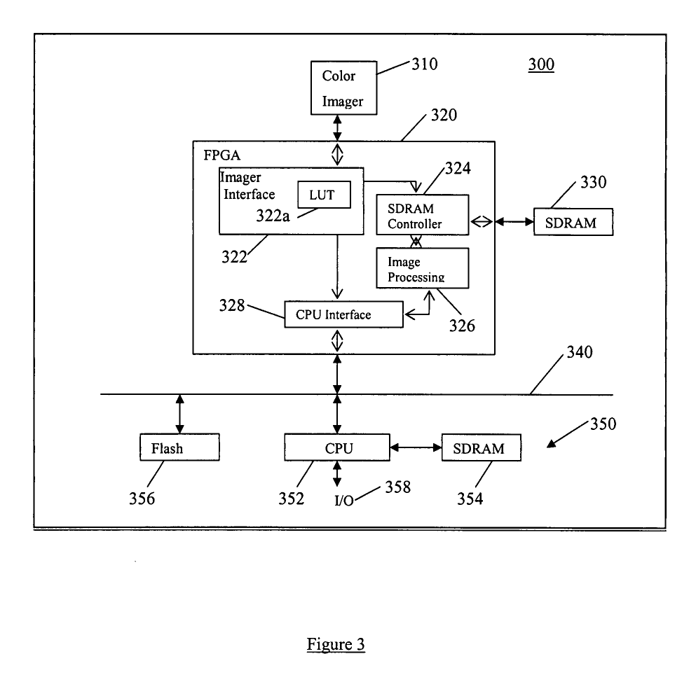

A system for identifying objects based on the color matching algorithm outlined above will now be described with reference to FIG. 3. The system 300 includes:
a Color Imager 310 for capturing images of objects to be identified. The imager in this example includes a 2D array of pixels with color filters over each pixel. The color filters are either red, green, or blue and are arranged in a Bayer pattern;
an image memory unit 330, which in this example is SDRAM, for storing captured images;
a processor, such as a central processing unit (CPU) 352 of a computer, such as a general-purpose computer. The processor is programmed to perform the color matching algorithm described above;
a volatile memory unit 354, which can be of any suitable type and in this example comprises SDRAM, serving as storage for CPU program, images, and various control parameters;
a Field Programmable Gate Array (FPGA) 320, which performs the following functions:
   Handling interface between the color imager 310, CPU 352, and image memory 330;
   Providing optional hardware assist for basic image processing tasks to improve performance (see below);
The FPGA 320 in this case is configured to include the following components:
   an imager interface 322 comprising a look-up table (LUT) 322a for subsequent basic image processing (see below);
   an SDRAM controller 324 for managing data flow from the imager interface 322 and to and from the image memory 330.
   an image processing unit 326 for performing basic image processing tasks in the optional hardware assist (see below); and
   a CPU interface 328 for interfacing the FPGA 320 to the CPU 352 via a communication bus 340;
a non-volatile memory unit 356, which can be any suitable type and is a Flash memory module in this example, serving as non-volatile storage of CPU program and FPGA configurations. The Flash module 356 in this case is interfaced with the CPU 352 and FPGA 320 via a communication bus 340.
   In operation, the system 300 captures and processes images of objects in the following sequence:
CPU 352 commands the FPGA 320 to capture an image and store it in either or both SDRAM memories 330 and 354.
FPGA 320 starts image capture sequence via control lines to the color imager 310.
Color imager 310 clears all its photosites and then exposes the photosites for the prearranged time.
After exposure the color imager 310 transfers the image to the FPGA 320, which in turn stores it to one or both SDRAM memories 330 and 354.
During the image transfer the FPGA 320 performs white balancing via the Look-Up-Table (LUT) 322a. The LUT 322a in this example was preloaded with values determined during the white balancing setup process.

The Color Match Tool Optional Hardware Assist function can be included in the FPGA 320 to improve performance; alternatively, these tasks are performed in the CPU 352. The functions that can be included in the hardware assist includes:
Bayer image to 24-bit RGB image conversion
   The FPGA 320 can be configured to convert the raw Bayer image from the color imager 310 to a 24-bit RGB image and store the resulting image in one or both SDRAM memories 330 and 354.
24-bit RGB to 8-bit grayscale image conversion
   The FPGA 320 can be configured to convert the 24-bit RGB image to an 8-bit grayscale image for use by subsequent grayscale tools, and for calculating the average intensity value of the color match ROI.

The system 300 further includes one or more input/output (I/O) ports 358 to perform functions including the following:
Interface to external devices and users;
Trigger input causing the imager 310 to capture an image;
Ethernet interface for communication with Graphical User Interface (GUI) and other external devices; and
Discrete input/output lines to control inspections and provide pass/fail status.
   The GUI can reside on a general-purpose computer, such as a PC, allowing the user to control the imager 310. Through a GUI, users can, among other things:
   Setup inspection parameters;
   Save inspection parameters;
   View/modify inspection parameters; and
   Run inspections.

### III. Summary

Thus, the present application discloses a method and system for comparing color contents of two images with improved confidence levels by comparing the histograms of the images (e.g., using histogram intersections) at progressively fine color resolutions and combining the results of the comparisons (e.g., using weighted averages).

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of comparing a first and a second image portions over at least a subset of a color space, the method comprising:
for each of the first and second image portions, generating a plurality of histograms of the image portion, wherein generating each of the plurality of histograms comprises:
dividing the subset of color space into a number of ranges different from the number of ranges for at least another one of the plurality of histograms for the same image, and
computing a count of pixels of the image portion falling within each of the ranges,
computing a degree of difference between each one of the plurality of histograms for the first image portion and a corresponding one of the plurality of histograms for the second image portion; and
computing a combination of the degrees of difference.

2. The method of claim 1, further comprising determining whether the first and second image portions are deemed to have the same colors based on the combination of the degrees of difference.

3. The method of claim 1, wherein dividing the subset of color space into a number of ranges comprises dividing the subset of color space into a number of chromaticity ranges.

4. The method of claim 3, wherein dividing the subset of color space into a number of chromaticity ranges comprises dividing the subset of color space into a number of ranges of normalized chromaticity, measured by intensities of two of red, green and blue divided by a sum of the intensities of red, green and blue.

5. The method of claim 1, wherein generating a plurality of histograms of the image portion comprises combining a plurality of color ranges of a first one of the plurality of histograms to form a color range of a second one of the plurality of histograms, and adding the count of pixels falling within the plurality of color ranges to form a count of pixels of the second one of the plurality of histograms.

6. The method of claim 5, wherein generating a plurality of histograms of the image portion comprises forming each of the number of color ranges of the second one of the plurality of histograms by combining a plurality of color ranges of the color ranges of the first one of the plurality of histograms.

7. The method of claim 1, wherein dividing the subset of color space into a number of ranges comprises dividing the subset of color space into a number of non-uniformly sized ranges.

8. The method of claim 7, wherein dividing the subset of color space into a number of non-uniformly sized ranges comprises more finely dividing the subset of color space at or near a region corresponding to gray or white than at or near a region corresponding to a saturated color.

9. The method of claim 8, wherein dividing the subset of color space into a number of chromaticity ranges comprises dividing the subset of color space into a number of ranges of normalized chromaticity measured by intensities of two of red, green and blue divided by sum of the intensities of red, green and blue, and wherein dividing the subset of color space into a number of non-uniformly sized ranges comprises more finely dividing the subset of color space in a region corresponding to a normalized chromaticity of about ⅓ and ⅓ for red and green, respectively, than any region corresponding to a normalized chromaticity of about either 0 or 1 for any of red and green.

10. The method of claim 1, wherein computing a degree of difference between each one of the plurality of histograms for the first image portion and a corresponding one of the plurality of histograms for the second image portion comprises computing a histogram intersection between the two histograms.

11. The method of claim 1, wherein computing a combination of the degrees of difference comprises computing a weighted sum of the degrees of difference.

12. The method of claim 11, further comprising assigning more weight to a difference between a first pair of histograms than to a difference between a second pair of histograms having a higher number of color ranges than the first pair.

13. The method of claim 11, further comprising assigning to each of the degrees of difference a weight for the weighted sum, wherein the weight monotonically decreases with increasing the number of color ranges.

14. The method of claim 13, wherein the weight is at least approximately proportional to the number of color ranges.

15. A method of identifying an object, the method comprising:
acquiring an image of the object;
selecting at least a region-of-interest (ROI) from the image;
generating a plurality of histograms of the ROI, wherein generating each of the plurality of histograms comprises:
dividing at least a subset of a color space into a number of ranges different from the number of ranges for at least another one of the plurality of histograms for the ROI, and
computing a count of pixels of the ROI falling within each of the ranges,
computing a degree of difference between each one of the plurality of histograms for the ROI and a corresponding one of a plurality of histograms for a reference image portion; and
computing a combination of the degrees of difference.

16. The method of claim 15, further comprising storing the plurality of histograms for the ROI and the plurality of histograms for the reference image portion in electronic memory.

17. The method of claim 15, further comprising determining whether the ROI and the reference image portion are deemed to have the same color content based on the combination of the degrees of difference.

18. The method of claim 15, wherein dividing the subset of color space into a number of ranges comprises dividing the subset of color space into a number of chromaticity ranges.

19. The method of claim 18, wherein dividing the subset of color space into a number of chromaticity ranges comprises dividing the subset of color space into a number of ranges of normalized chromaticity, measured by intensities of two of red, green and blue divided by a sum of the intensities of red, green and blue.

20. The method of claim 15, wherein generating a plurality of histograms of the image portion comprises combining a plurality of color ranges of a first one of the plurality of histograms to form a color range of a second one of the plurality of histograms, and adding the count of pixels falling within the plurality of color ranges to form a count of pixels of the second one of the plurality of histograms.

21. The method of claim 20, wherein generating a plurality of histograms of the image portion comprises forming each of the number of color ranges of the second one of the plurality of histograms by combining a plurality of color ranges of the color ranges of the first one of the plurality of histograms.

22. The method of claim 15, wherein dividing the subset of color space into a number of ranges comprises dividing the subset of color space into a number of non-uniformly sized ranges.

23. The method of claim 22, wherein dividing the subset of color space into a number of non-uniformly sized ranges comprises more finely dividing the subset of color space at or near a region corresponding to gray or white than at or near a region corresponding to a saturated color.

24. The method of claim 23, wherein dividing the subset of color space into a number of chromaticity ranges comprises dividing the subset of color space into a number of ranges of normalized chromaticity measured by intensities of two of red, green and blue divided by sum of the intensities of red, green and blue, and wherein dividing the subset of color space into a number of non-uniformly sized ranges comprises more finely dividing the subset of color space in a region corresponding to a normalized chromaticity of about ⅓ and ⅓ for red and green, respectively, than any region corresponding to a normalized chromaticity of about either 0 or 1 for any of red and green.

25. The method of claim 15, wherein computing a degree of difference between each one of the plurality of histograms for the ROI and a corresponding one of the plurality of histograms for the reference image portion comprises computing a histogram intersection between the two histograms.

26. The method of claim 15, wherein computing a combination of the degrees of difference comprises computing a weighted sum of the degrees of difference.

27. The method of claim 26, further comprising assigning more weight to a difference between a first pair of histograms than to a difference between a second pair of histograms having a higher number of color ranges than the first pair.

28. The method of claim 26, further comprising assigning to each of the degrees of difference a weight for the weighted sum, wherein the weight monotonically decreases with increasing the number of color ranges.

29. The method of claim 28, wherein the weight is at least approximately proportional to the number of color ranges.

30. A system for identifying an object, the system comprising:
an imaging device adapted to capture an image of at least a portion of the object;
an image processing unit interfaced with the imager and adapted to receive and process the image, the image processing unit comprising:
one or more memory units adapted to store the image and a plurality of histograms for a reference image portion;
a user interface; and
one or more processors configured to:
select at least an region-of-interest (ROI) from the image;
generate a plurality of histograms of the ROI, wherein generating each of the plurality of histograms comprises:
dividing at least a subset of a color space into a number of ranges different from the number of ranges for at least another one of the plurality of histograms for the ROI, and
computing a count of pixels of the ROI falling within each of the ranges,
compute a degree of difference between each one of the plurality of histograms for the ROI and a corresponding one of the plurality of histograms for the reference image portion; and
computing a combination of the degrees of difference.

31. A method of comparing a first and a second image portions over at least a subset of a color space, the method comprising:
for each of the first and second image portions, generating a plurality of statistical representations of the image portion over the subset, each representation relating to a distribution of pixels over a plurality of ranges in the subset, the subset being subdivided into a different number of ranges in each respective one of the representations;
computing a degree of difference between each one of the plurality of representations for the first image portion and a corresponding one of the plurality of representations for the second image portion; and
computing a combination of the degrees of difference.
